(19) United States
(12) Patent Application Publication
(10) Pub. No.: US 2016/0347486 A1
(43) Pub. Date: Dec. 1, 2016

(54) METHOD FOR LOADING A 3D FLEXIBLE POUCH TO BE FILLED, SYSTEM FOR LOADING AND STORING THIS FLEXIBLE POUCH AND ASSOCIATED SUPPORT DEVICE

(71) Applicant: SARTORIUS STEDIM FMT SAS, Aubagne (FR)

(72) Inventors: Stephane BAUD, La Bouilladisse (FR); Frederic BERNARD, La Cadiere D'azur (FR)

(21) Appl. No.: 15/116,605

(22) PCT Filed: Feb. 5, 2015
(86) PCT No.: PCT/FR2015/050279

§ 371 Date: Aug. 4, 2016

(30) Foreign Application Priority Data
Feb. 6, 2014 (FR) 14 50906

(51) Int. Cl. B65B 3/04; B65B 61/20; A61J 1/10; B65B 67/12

(52) U.S. Cl. CPC B65B 3/045; B65B 67/1233; B65B 61/20; A61J 1/10

(57) ABSTRACT

A support device (20), mounted on an upper edge of a container (3), includes lifting elements that define a support surface (22) which extends transversely outwards from an inner edge (55). The upper end (2b) of a flexible pouch for biopharmaceutical product can rest on this support surface, the rest of the 3D-type pouch extending into the container. The slot (23) which separates the support surface into two portions defines a guide path for a flexible supply line (9a, 9b) for the pouch (2) that is connected at its bottom to the end (2b). A convex surface is formed at the rear end of the slot and above the edge of the container, so as to guide and facilitate the passage of the line (9a) into the housing, when the filling state is sufficiently advanced. The causes of poor deployment of the pouch are thus minimized, without human intervention.

### FIELD OF THE INVENTION

The invention relates to the field of biopharmaceutical fluid packaging and, in particular, to the filling of a flexible reservoir in the form of a 3D (three-dimensional) flexible pouch which is to be placed in a rigid container. The invention concerns a method for loading such a flexible pouch when it is to be filled, a system for loading and storing this flexible pouch, and a support and guide device for implementing this loading method.

The term “biopharmaceutical product” is understood to mean a product of biotechnology—culture media, cell cultures, buffer solutions, artificial nutrition liquids, blood products and blood product derivatives—or a pharmaceutical product or more generally a product for use in the medical field. Such a product is in liquid, paste, or possibly powder form. The invention is also applicable to the filling of flexible pouches with other products but subject to similar requirements concerning packaging.

### BACKGROUND OF THE INVENTION

A 3D pouch for receiving such a biopharmaceutical product is known, comprising a lower end wall, an upper end wall, and a flexible side wall, which can be in two extreme states—folded flat, and unfolded and deployed—and can be deformed to change from one to the other of these states or may be in any intermediate state. The walls of the pouch, of a plastic material such as polyethylene or a complex comprising polyethylene, define an internal space, which in the folded state is of minimal volume and in the unfolded and deployed state is of maximal volume. This space is intended to receive the biopharmaceutical product for storage, processing, and/or control. Such a flexible pouch, which is biocompatible and disposable, can have a significant volume of at least 50 liters and up to 3,000 liters or more, which justifies calling it “3D”. Such a pouch thus provides a significant capacity while being easy to store. An example of such a pouch is described in international patent application WO00/04131 or in patent FR 2781202. When filled with biopharmaceutical product, such a 3D flexible pouch must be placed in a rigid container which supports it externally. This type of rigid container is suitable for storage, possibly with the possibility of stacking. Some rigid containers are also used for transport, while others are more suitable for weighing operations. The use of a rigid container is therefore very widespread for the handling of fluids contained in a 3D flexible pouch. The storage housing of the container is accessible through an upper transverse opening defined by an upper edge, and is possibly accessible through side doors.

In one implementation, such a rigid container comprises a lower transverse wall and an upright axial peripheral side wall delimiting an upper transverse opening for accessing a housing defined by the inner faces of these walls, suitable for receiving the pouch containing the biopharmaceutical fluid which presses against the inner faces. Patent EP-A-1012073 discloses such a container, further provided with a protective containing wall adapted to be placed transversely in the housing of the rigid container, having dimensions such that the transverse clearance between its free outer peripheral edge and the inner face of the facing side wall of the rigid container is limited.

The flexible pouch is conventionally placed in the storage housing of the rigid container in order to begin loading it. Given the significant weight and the volume of the pouch when filled and inflated, the pouch is initially positioned at least in part on the bottom of the housing formed by the lower transverse wall. This pre-positioning eliminates having to manipulate or transport the pouch when in the filled state. The pouch has an upper end at a distance from the bottom of the housing and typically provided with at least one connection port, and preferably at least two ports, used for filling. The upper end comprises, for example, an inlet port or a port for introducing a biopharmaceutical product and a gas supply port. Corresponding supply lines, each connected to a supply source which is typically external to the rigid container, traverse or extend along the upper transverse access opening, for connection to their respective ports. Alternatively, the filling may be done using a lower supply line. Patent EP-B1-0326730 describes a filling of this type, with the disadvantage that the flexible pouch is more complex, as it is provided with side flaps which limits the usefulness of this type of option. It is generally desirable to limit the complexity and cost of the 3D flexible pouch since it is a single-use disposable item.

It is also known, for pouches of very high capacity (for example 1500 L or 3000 l), to use a hoist system as described in patent US20110271646 to equip the rigid container. The 3D flexible pouch that is used is conventional, but it is necessary to preposition the flexible pouch by lifting it vertically using the hoist system. In this case, the filling with biopharmaceutical fluid is performed from below. The use of a hoist system, which requires attachments to the pouch, is relatively restrictive for an operator.

In practice, the unfolding of the flexible pouch during filling requires human supervision, as incorrect deployment related to pouch flexibility and the mobility of the supply lines can occur. The following have been observed without human intervention:
the flexible pouch catching on the inner faces of the axial wall of the rigid container, resulting in incorrect unfolding and the risk of damage to the disposable flexible pouch,
incorrect orientation of the flexible pouch within the housing of the rigid container, which reduces the capacity of the flexible pouch,
interfering blocking position of the connected lines, which causes the flexible pouch to fill incorrectly, preventing it from reaching a nominal fill volume and resulting in the risk of detachment at the ports of the flexible pouch.

### SUMMARY OF THE INVENTION

There is therefore a need for a simple, economically viable solution, facilitating deployment of the pouch during its filling and eliminating the need to watch for the pouch catching on the container.

According to a first aspect, the invention relates to a method for loading, in the storage housing of a rigid container, a 3D flexible pouch that can be filled with a biopharmaceutical product by means of at least one flexible supply line.

The loading method comprises, before filling, the steps consisting essentially of:
extending the flexible pouch, in an initial non-filled state, along a given inner face of the storage housing, so as to define a lower end and an upper end which are arranged one on either side of said upper transverse opening, wherein the upper end of the flexible pouch comprises at least one upper port to which said flexible supply line is connected, said upper port being arranged on a given face of the flexible pouch in its initial non-filled state;
maintaining the upper end outside of the storage housing.

More particularly, the loading method comprises the steps consisting essentially of:
providing a support surface on the rigid container, by means of at least one support device mounted along a determined side of the upper edge,
orientating and positioning the flexible pouch so that a first portion of the given face of the flexible pouch is face to face with the given inner face and so that a second portion of said given face of the flexible pouch (which is part of the upper end) is in contact with the support surface, such that said flexible supply line connects to the flexible pouch from underneath (relative to the support surface), and
before or during filling, inserting said flexible supply line into a slot that separates said support surface into two surface portions, while keeping the second portion of the given face, which is part of the upper end of the flexible pouch, placed against the support surface,
during filling, guiding said supply line by a convex guide surface provided in the support device and extending between the two surface portions, the guide surface covering a portion of the upper edge and delimiting one end of the slot, whereby the supply line can be lifted above the upper edge during filling, when the upper end of the flexible pouch is moved into the storage housing.

It is thus possible to control the proper positioning of the upper end of the pouch and the associated flexible supply lines as filling begins and to guide the movement of the flexible supply lines, at least until the upper end has completed its tilt in the storage housing. The use of a slot for positioning the supply lines makes it possible to place these lines closer to the upper edge and to limit their lateral movement. Surprisingly, it has been observed that maintaining the upper end on the support surface and guiding the supply lines in a transverse slot prevents:
the initial retention of fluid in retention areas distanced from the lower end of the pouch; indeed, such maintaining on a support surface (which is mounted on the upper edge) provides a substantially horizontal or downward slope from the upper end to the upper opening of the container, so that when filling begins the flow of fluid is guided toward the inside of the storage housing;
the reduced mobility of the flexible supply lines prevents the pouch from twisting, significantly reducing incorrect unfolding of the pouch;
line blockage, as the convex guide surface eliminates pressing against sharp corners or edges.

In one embodiment, the support surface is placed on the rigid container so as to extend transversely and laterally outwards relative to the given inner face of the storage housing, whereby the upper end of the flexible pouch is in a laterally offset position relative to the storage housing when the upper end is resting on the support surface.

According to one feature, before filling, another flexible line is connected to a lower port located in the lower end of the flexible pouch, and this other flexible line is inserted into a through-hole to pass through the bottom of the storage housing.

According to one feature, the flexible pouch is filled using at least one flexible supply line, and preferably two flexible supply lines, and a corresponding number of upper ports, preferably two upper ports, provided in the upper end of the flexible pouch, on the side of the given face. During filling, at least one flexible supply line is guided by the convex guide surface. Two flexible supply lines may be inserted into the slot which extends, for example, between two coplanar shelves.

In various embodiments of the method, one or more of the following features may possibly be included:
the flexible pouch has a capacity of between 100 and 1000 L, preferably between 200 and 500 L, the storage housing of the rigid container being adapted to contain the entire contents of the flexible pouch in a filled state;
the support device is removably attached to the determined side of the upper edge;
the upper end of the flexible pouch is placed at a height level at least equal to the height level of the determined side of the upper edge, when it is resting on the support surface;
the support surface and the given inner face form planes which are secant, so that the angle formed between said first portion and said second portion is between 60° and 130° prior to filling, preferably between 70° and 110°, and more preferably between about 90° and 100°;
the second portion of said given face is part of the upper end of the flexible pouch, the upper end of the flexible pouch being moved to inside the storage housing in a passive manner under the simple effect of the increase in mass and volume of the assembly formed by the flexible pouch and the biopharmaceutical product contained in the flexible pouch;
the support surface is moved from a folded position that enables attachment of the support device, to a deployed position that enables the support surface to support the upper end of the flexible pouch at a height level that is higher than the upper edge;
the deployed position is locked by the contact of at least one pin that is integral in rotation with the support surface, against a stop of the support device which is integral to a fastening element attached to the rigid container;
the upper end of the flexible pouch extends parallel to the support surface which is substantially planar, prior to filling;
the flexible supply line is initially placed at a distance from the guide surface when the upper end of the flexible pouch is placed on the support surface, the insertion of the flexible supply line into the slot optionally being limited by a spacer member integral to the support device, and the lower end of the flexible pouch is initially maintained at a distance from a distal wall of the container opposite to the given inner face of the container, the unfolding of the flexible pouch along the bottom of the storage housing allowing, as the flexible pouch is filled, the pulling of the upper end of the flexible pouch inwardly into the storage housing, so that said flexible supply line engages with and moves against the guide surface.

According to a second aspect, the invention relates to a system for loading and storing a 3D flexible pouch to be filled with a biopharmaceutical product by at least one flexible supply line located at an upper end of the flexible pouch, for the implementation of the method according to the invention, the system comprising a rigid container having a bottom, a side wall extending longitudinally from the bottom to an upper edge defining an upper transverse opening, so as to define a storage housing for receiving the flexible pouch in a filled state, the storage housing being accessible through the upper transverse opening,

this system comprising, on a determined side of the upper edge, a support device which comprises:
a fastening element on said determined side of the upper edge;
lifting means which extend between an inner edge adjacent to the upper transverse opening and at least one outer edge, the lifting means defining a support surface extending transversely outwards from the inner edge to said outer edge, the support surface being adapted to maintain the upper end of the flexible pouch to be filled outside of the storage housing;
a slot which separates said support surface into two surface portions, suitable for the passage of the flexible supply line when the upper end of the pouch is resting on the support surface;
a convex guide surface which extends between the two surface portions and defines one end of the slot, the guide surface covering a portion of the upper edge.

“Lifting” is understood to mean maintaining the upper end of the flexible pouch at a height level close to that of the upper edge, which allows positioning this upper end in a predominantly horizontal plane. This transverse orientation of the area where the supply lines are connected allows bringing forward the port for connecting the flexible supply line against the guide surface. The lifting prevents the impediments associated with the catching of the flexible supply line, and/or a clamping member that is generally mounted on this flexible line, on the underside of a container lip. For the guide surface, the term “convex” is understood to mean presenting a generally curved appearance and projecting towards the area where the supply line and the pouch connect, whereby the flexible line or lines are maintained face-to-face with the guide surface and between the two surface portions. The convex curvature of the guide surface facilitates movement of the upper end of the flexible pouch to the storage housing, smoothly and without catching.

In one embodiment, the support surface extends at a height level at least equal to the height level of the determined side of the upper edge.

In various embodiments of the system for loading and storing a 3D flexible pouch, one or more of the following features may possibly be included:
the convex guide surface has a continuous rounded C-shaped cross-section;
the distance between the inner edge and the outer edge is smaller than the smallest dimension of the storage housing; said distance may be between 10 and 40% of a width of the storage housing;
to allow detachable attachment of the support device on the determined side of the upper edge, the fastening element comprises at least one clasping element;
the clasping element or element(s) comprise a positioning member having a U-shaped cross-section forming two parallel arms spaced apart by a distance greater than the thickness of the determined side of the upper edge, and clamping means to lock the positioning member in place;
the clamping means comprise an elongate element which defines a first support end intended to be in contact with an outer face of the rigid container, and a second end which traverses a given arm among the arms of the positioning member;
the clamping means comprise a clamping adjustment element that is movable relative to the elongate element and that engages with the second end of the elongate element in order to adjust the relative position of the elongate element with respect to the given arm;
the slot is located in a central position on the determined side, such that a virtual vertical midplane exists which passes through the slot and through the through-hole.

Furthermore, a support device is provided that is adapted to be combined with a rigid container to form the loading and storing system according to the invention.

This support device comprises:
a fastening element which extends longitudinally between two ends and has a lower face adapted for attachment to the determined side of the upper edge;
lifting means which extend between at least one outer edge and an inner edge adjacent to the upper transverse opening in a state where the support device is mounted on the rigid container, the lifting means defining a support surface extending transversely outwards from the inner edge to said outer edge, the support surface forming an upper face of the support device;
a slot separating said support surface into two surface portions, preferably opening onto the side of the outer edge, the slot defining a passage for the flexible supply line when the upper end of the pouch is resting on the support surface;
a convex guide surface which extends between the two surface portions and defines one end of the slot, the guide surface being opposite to the inner face of the fastening element and adapted to cover a portion of the upper edge in a state where the support device is mounted on the rigid container, the support surface generally extending in a plane which intersects the guide surface or lies above the guide surface, such that the support surface maintains the upper end of the flexible pouch to be filled outside of the storage housing and preferably at a predefined height level.

In one embodiment, the convex guide surface comprises a rear end portion of the support surface, extending in a longitudinal direction parallel to the fastening element and having a continuous curved C-shaped cross-section, wherein, when the support surface defines a horizontal plane, the lower face of the fastening element defines at least one longitudinal cavity opening vertically onto the side opposite the support surface and opening horizontally via at least one of the ends of the fastening element.

In various embodiments of the support device, one or more of the following arrangements may possibly be used:
the device has one or more shelves, for example a first shelf for defining all or part of one of the two surface portions of the support surface, and a second shelf for defining all or part of the other of the two surface portions of the support surface;
the first shelf and the second shelf are coplanar and each have a lateral edge forming a side of the slot, the slot opening to the exterior on the outer edge side;
a spacer member distinct from the guide surface is provided which extends transversely to the slot between two ends of which one is integral to the first shelf and the other is integral to the second shelf;
the spacer member is offset frontward relative to the rear end of the slot;
the spacer member defines a front surface oriented toward a front end of the slot and is adjustable in position relative to the lifting means so as to adjust a distance between said front surface and the inner edge of the lifting means;
the support device comprises a hinge on the fastening element, so that the lifting means are movable in rotation, about a longitudinal axis of the fastening element, between a folded position and a deployed position;
at least one locking member is provided for locking the lifting means in the deployed position;
at least one guide slot is formed on the fastening element, about the longitudinal axis, to guide a rotational movement of all or part of the lifting means, said guide slot respectively defining a front stop and a rear stop, the rear stop preventing said rotational movement when the deployed position of the lifting means is reached.

### BRIEF DESCRIPTION OF THE DRAWINGS

Other features and advantages of the invention will become apparent from the following description of several embodiments, given as non-limiting examples, with reference to the accompanying drawings in which:

FIG. 1 is a perspective view representing a system for loading and storing in a first embodiment, intended to be loaded with a 3D flexible pouch that is to be filled with biopharmaceutical fluid.

FIG. 2A is a bottom view of a 3D flexible pouch intended to be housed in the rigid container of the system of FIG. 1.

FIG. 2B is a side view of the flexible pouch of FIG. 2A, in a configuration with two parallel fold lines.

FIG. 2C is a perspective view of a 3D flexible pouch in the deployed state and filled with a biopharmaceutical fluid.

FIG. 3 is a perspective view which illustrates the positioning of the 3D flexible pouch before filling begins, with the upper end of the pouch retained on the support device of the system of FIG. 1.

FIGS. 4A and 4B are sectional views illustrating the positioning of the 3D flexible pouch as it is filled and showing the connection between a pumping device and a flexible supply line which is connected to a port at the upper end of the 3D flexible pouch.

FIGS. 5A-5D each respectively illustrate a filling state of the 3D flexible pouch held by the support device, at different stages of the filling process.

FIG. 6 is a view similar to that of FIG. 1, but with a different rigid container and with the support device in a folded configuration.

FIG. 7 is a side view showing a support device according to the invention, with the lifting means in a deployed and functional configuration.

FIG. 8 shows a variant of the support device, with a spacer member extending transversely in the slot and initially keeping the flexible supply line or lines away from the rear end of the slot.

FIGS. 9A and 9B show two variants that allow adjusting the position of the spacer member.

FIG. 10 illustrates another variant of the support device, provided with a spacer member.

FIG. 11 shows a support device in a non-folding variant.

### DETAILED DESCRIPTION

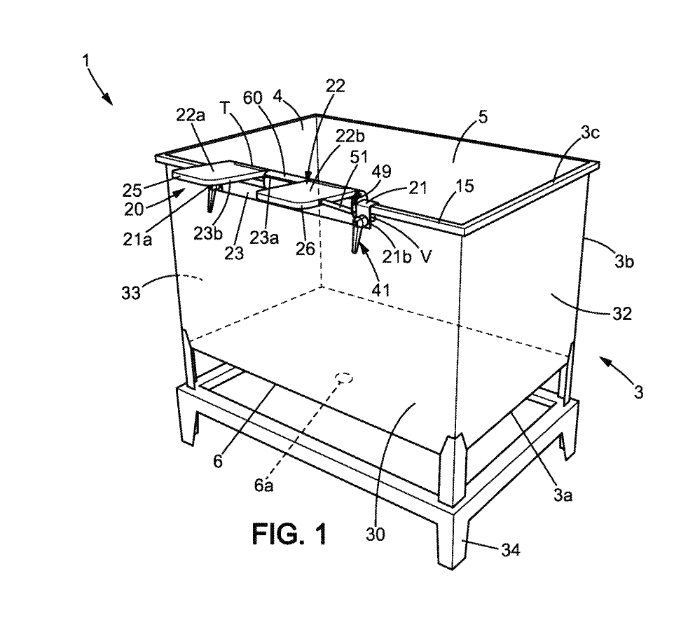

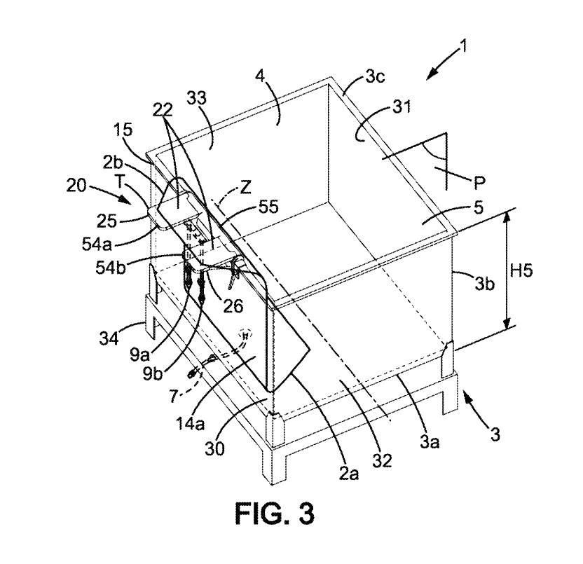

An exemplary loading and storing system 1 for a 3D flexible pouch 2 is visible in FIGS. 1 and 3. The loading and storing system 1 comprises a rigid container 3 which has a bottom 3a, a side wall 3b extending longitudinally from the bottom 3a to an upper edge 3c delimiting an upper transverse opening 4, so as to define a storage housing 5 intended to receive the flexible pouch 2 in a filled state. The storage housing 5 is accessible via the upper transverse opening 4. The bottom 3a is here defined by a lower transverse wall 6 and may, where appropriate, include a through-hole 6a for an optional flexible line 7 connecting to a lower end 2a of the flexible pouch 2. In this case, the through-hole 6a may possibly be provided with an adjustable pinch valve (not shown) of a type known per se and adapted to lock the position of the flexible line 7 traversing the bottom 3.

Under normal conditions, the lower transverse wall 6 is arranged horizontally or substantially horizontally while the side wall 3b is upright and arranged vertically or substantially vertically, possibly flaring slightly outward from the lower transverse wall 6. The description is provided for this situation.

The words “horizontal”, “vertical”, “lower”, “upper”, etc. are understood as being in reference to these conditions. Of course, the rigid container 3 may be placed differently in certain cases, for example for cleaning.

The rigid container 3, of plastic or some other synthetic or metal material, preferably stainless steel, comprises for example an assembly—where appropriate detachable and re-attachable—of a plurality of parts generally in the form of solid or substantially solid panels, flat or substantially flat, as well as parts for connection and/or reinforcement, and any accessories. In the non-limiting example of FIGS. 1 and 3, the side wall 3b is formed by a front panel 30, a back panel 31, and two connecting panels 32 and 33 which extend between the front panel 30 and back panel 31. The rigid container 3 may have a stand 34 at the bottom, for example in the form of feet (here four feet) which extend vertically from the corner regions of the transverse wall 6. This stand 34, which extends here below the lower transverse wall 6, allows, among other things, raising the lower transverse wall 6 above the ground and providing access to or allowing connection to ports, fittings, lines, or the like. Such a stand 34 also allows leaving space for the forks of a transport vehicle such as a forklift.

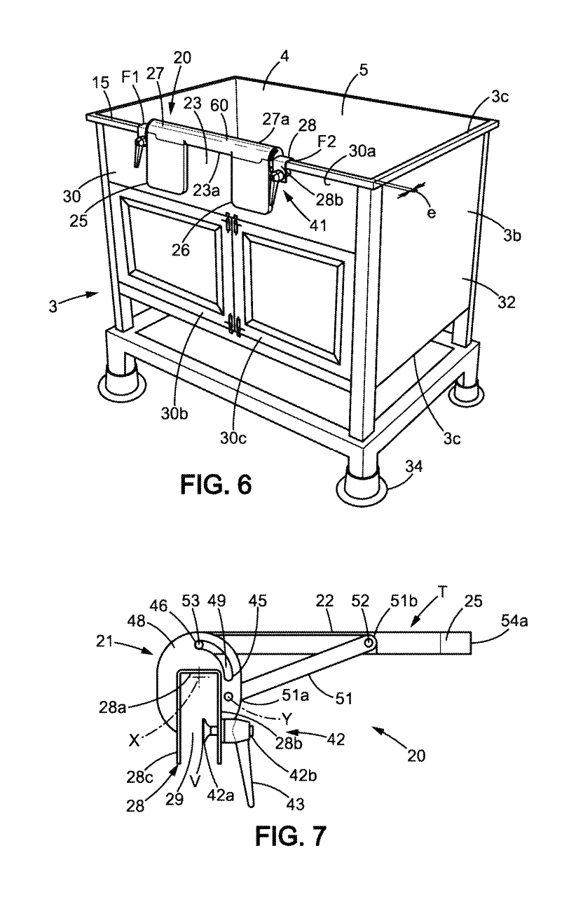

More generally, it is understood that the rigid container 3 can have various configurations, since it is specially adapted for receiving and retaining a 3D flexible pouch 2 specially designed to contain a biopharmaceutical fluid B as defined above. In the embodiment represented in FIG. 6, the rigid container 3 comprises, on its side wall 3b or on one or more of its component panels, one or more doors 30b, 30c or one or more openings allowing access to the interior of the storage housing 5. Where appropriate, such openings or accesses are located so as to correspond to ports, openings, hoses and lines provided on the pouch 2 or associated with it. It is possible to have similar access provided in a lid (not shown).

In FIG. 3, the flexible pouch 2 is partially inserted into the housing 5 before the filling process begins. The flexible pouch 2 is placed along a given inner face 8 of the storage housing 5, so that the lower end 2a is folded and lies substantially flat against the bottom 3, while the upper end 2b of the flexible pouch 2 extends beyond the upper transverse opening 4, to outside the storage housing 5. Thus the flexible line or lines 9a, 9b which are connected to the upper end 2b of the flexible pouch 2 are initially maintained outside the storage housing 5. The through-hole 6a is preferably at a distance from the inner face 8 here formed by the front panel 30 and can allow, by cooperating with flexible line 7, centering the flexible pouch 2 relative to the bottom 3a of the rigid container 3. One will note that the ends 2a and 2b of the flexible pouch 2 do not extend along the inner face 8 but extend transversely to it.

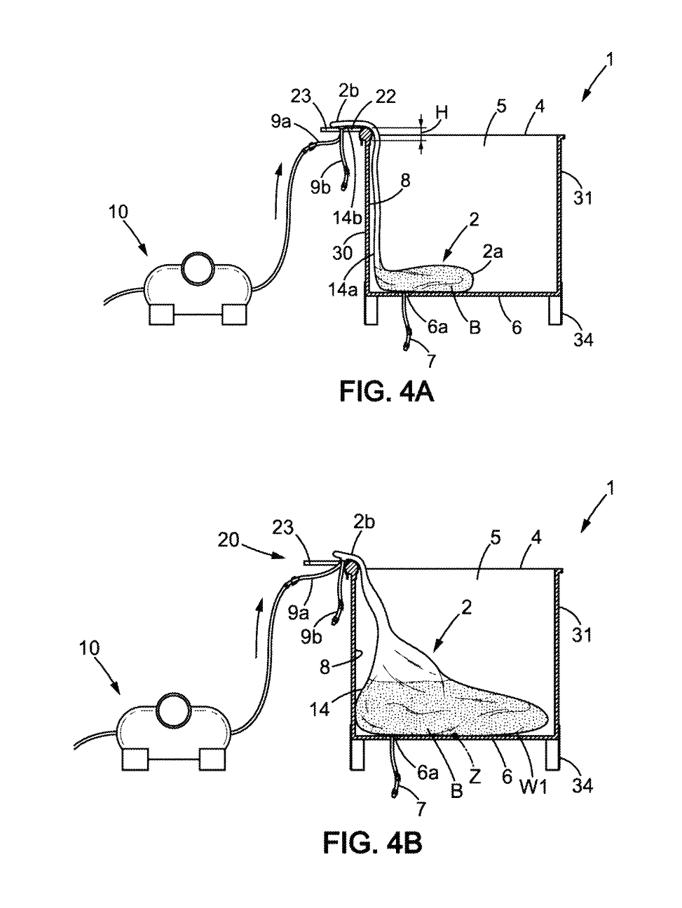

As is clearly visible in FIG. 4A, the external positioning of flexible lines 9a, 9b facilitates connection to a pumping device 10 which is itself connected to or incorporates a source of biopharmaceutical fluid B. In the following description, a line connected to the upper end 2b is referred to as a flexible supply line. Furthermore, each of flexible lines 7 and 9a-9b is preferably equipped with a clamping member such as clamp C1, C2, C3. “Along” the given inner face 8 is understood to mean that the flexible pouch 2 is positioned against or possibly at a small distance from the inner face 8, with no element or accessory inserted between the main part of the flexible pouch 2 (this part being complementary to ends 2a and 2b) and the inner face 8. This therefore means placing the flexible pouch 2 completely away from the opposite inner face formed by panel 31, preferably with at least one contact with the lower and/or upper side of this inner face 8.

The given inner face 8 may be planar and substantially vertical, particularly when the flexible pouch 2 forms a parallelepiped in the filled state. The bottom of the pouch 2, formed by the bottom wall W1, is in this case is in contact with the transverse wall 6 as illustrated in FIG. 4A. Here, the dimensions of the bottom wall W1 (except for the thickness) can be considered to be identical or substantially equal to those of the bottom 3a of the storage housing 5.

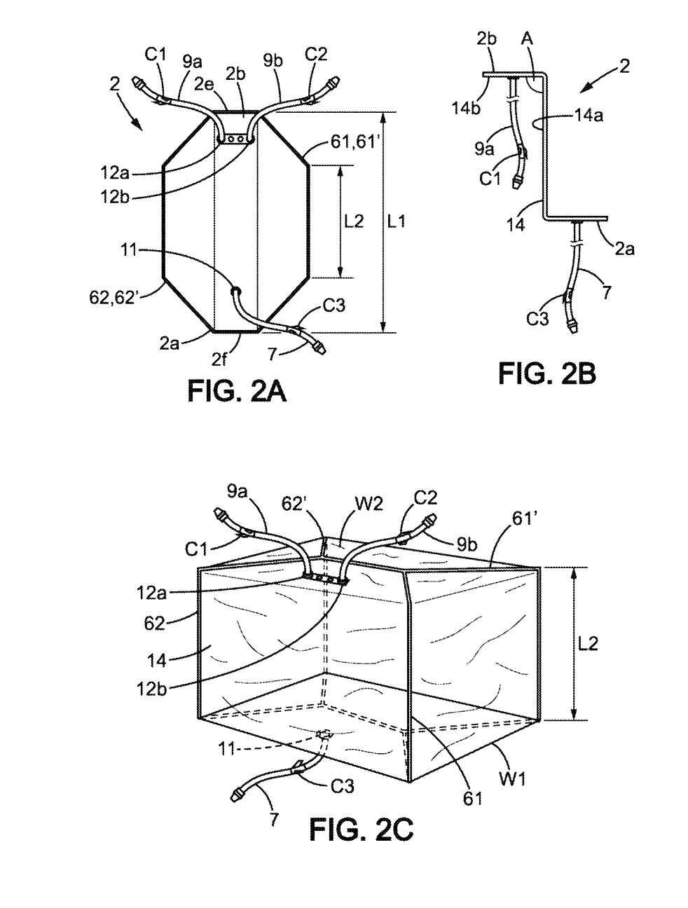

Referring to FIG. 3, the housing 5 may have a depth H5 substantially corresponding to the length of the longest side L2 of the hexagonal shape of the flexible pouch 2 (shape clearly visible in FIG. 2A where the flexible pouch 2 is in a non-filled state). The rigid container 3 has a parallelepiped shape with a length L and a width L3 (therefore L≧L3). The depth H5 is preferably greater than the width L3 and may also be greater than the length L. The housing 5, which is deeper than it is wide, enables the flexible pouch 2 containing the biopharmaceutical fluid B, when filled as shown in FIG. 2C, to press against each of the inner faces of the rigid container 3 of parallelepiped shape. It is understood that the length L1 of the flexible pouch 2 in its initial state before filling, when measured from the lower end 2a to the upper end 2b, is greater than the depth H5 and greater than the height of the flexible pouch 2 in its deployed and filled state (this height being substantially equal to length L2).

Alternatively, the dimensions H5, L, and L3 may be similar, so that the housing 5 has a general shape similar to a cube or substantially similar to a cube.

These lengths may be, depending on the case, between about 400 cm and 1200 cm, such that the internal volume of the housing 5 may be about 50 liters or 100 liters, but may also reach 1000 liters, these data being exemplary but not limiting. Thus the depth H5 may vary between 520 cm and 1000 cm for typical embodiments. A capacity of between 200 and 500 L may be preferred.

Depending on the dimensions, the lower transverse wall 6 and/or the side wall 3b may have external reinforcing ribs.

Of course, the dimensions of the rigid container 3 and those of the 3D flexible pouch 2 are adapted to one another, so that the housing 5 is able to receive the flexible pouch 2.

The 3D flexible pouch 2 will be now described with reference to FIGS. 2A, 2B, and 2C. Such a pouch 2 comprises a bottom wall W1, a top wall W2, and a flexible side wall which may be in two extreme states—folded flat, or unfolded and deployed—and be reshaped to change from one to the other of these states or be in any intermediate state. When the flexible pouch 2 is filled with biopharmaceutical fluid B, it is inflated to a greater or lesser degree. While its bottom wall W1 can rest on the inner face of wall 6 of the rigid container 3, its side wall presses against the inner face of the side wall 3b of the rigid container 3.

The flexible pouch 2 has one or more inlet or filling or supply openings, in particular in the form of ports 12a-12b (called upper ports in the following), in particular in the top wall W2, and one or more outlet or discharge or evacuation openings, in particular in the bottom wall W1, in particular in the form of ports 11. The rigid container 3 is arranged to provide access to these openings, for example through the through-hole 6a.

The inlet openings are adapted to be closed when necessary and/or a clamp member C1-C2 is used to close off access to the interior of the flexible pouch 2. Similarly, the outlet opening or openings are adapted to be open when necessary and/or a clamp member C3 is used to allow passage through the flexible line 7.

As illustrated in FIG. 2A, the 2D flexible pouch in the folded state has two opposing flat faces, with ports 11 and 12a-12 being provided on one of these faces 14. The two other faces (visible in 2C) are folded. The pouch portions forming these two other faces have the shape of flattened bellows and are inserted between the two opposing faces. The flat state of the flexible pouch 2, as obtained immediately after manufacture, is allowed by the superposition of weld seams 61, 61′ and 62, 62′.

As can be seen in FIG. 2C, the four longitudinal weld seams 61, 61′, 62, and 62′ formed between two walls forming adjacent faces are created by three thermal type welds, and K-shaped welds are formed as described in patent EP 1012227 B1.

Referring to FIG. 1, after filling, a removable cover provided with gripping and handling members (not shown) may be placed, along its annular edge, on the free upper edge 3c of the rigid container 3. Where appropriate, means for quickly locking such a cover in the closed position are provided. The upper opening 4 is then covered.

In FIGS. 2A-2C, one can see that the respective ports 11, 12a-12b for connecting flexible lines 7 and 9a-9b are provided on the same given face 14 of the flexible pouch 2. As a result, as illustrated in FIGS. 3 and 4A, it is understood that the flexible pouch 2 is positioned on the loading and storing system 1 such that:
the lower end 2a of the flexible pouch 2 lies against the bottom 3 on the side that is the given face 14 of the flexible pouch 2;
a first portion 14a of the given face 14 is face-to-face with the given inner face 8 of the rigid container 3; and
the upper end 2b of the flexible pouch 2 is folded over a determined side 15 of the upper edge 3c, and flexible supply line 9a connects to the flexible pouch 2 from below at a second portion 14b of the given face 14.

Referring to FIGS. 1 and 3-4A, the loading and storing system 1 comprises, on the determined side 15 of the upper edge 3c, a support device 20 which extends this determined side 15 radially outward. The support device 20 comprises at least one fastening element 21 for anchoring to the rigid container 3, this fastening element 21 sitting on the determined side 15 in the attached state. Although in the example shown in FIG. 1, the fastening element 21 is one piece, it is understood that the anchoring may be accomplished by at least two anchors attached to two distinct areas of the determined side 15. It is also possible to form the fastening element 21 with two parts which may or may not be identical, possibly telescoping. In the embodiment of FIG. 1, the fastening element 21 extends longitudinally between two ends 21a, 21b and has a lower face adapted for attachment to said determined side 15 of the upper edge 3c. This lower face is preferably generally concave.

The rigid container 3 typically forms a parallelepiped and, more generally, may have a front panel 30 which extends in a vertical or substantially vertical plane and a determined side 15 of the upper edge 3c, located on the side of the front panel 30, which is substantially horizontal. The support device 20 may advantageously be attached only on this determined side 15, preferably at a distance from the corners of the container 3.

Referring to FIGS. 1 and 6-7, lifting means T are mounted on the fastening element 21, preferably hinged about an axis X parallel to the determined side 15 in the assembly configuration. These lifting means T define a support surface 22 serving to hold the upper end 2b of the flexible pouch 2 outside of the storage housing 5, preferably at a height level at least equal to the height level of the determined side 15 when it is resting on the support surface 22, as can clearly be seen in FIGS. 3 and 4A. The lifting means T are provided with a slot 23 which separates the support surface 22 into two surface portions 22a, 22b. Before or during filling, the flexible supply line 9a and possibly one or more other adjacent flexible lines 9b are inserted into this slot 23, while keeping a second portion 14b of the given face 14, which is part of the upper end 2b of the flexible pouch 2, placed against the support surface 22.

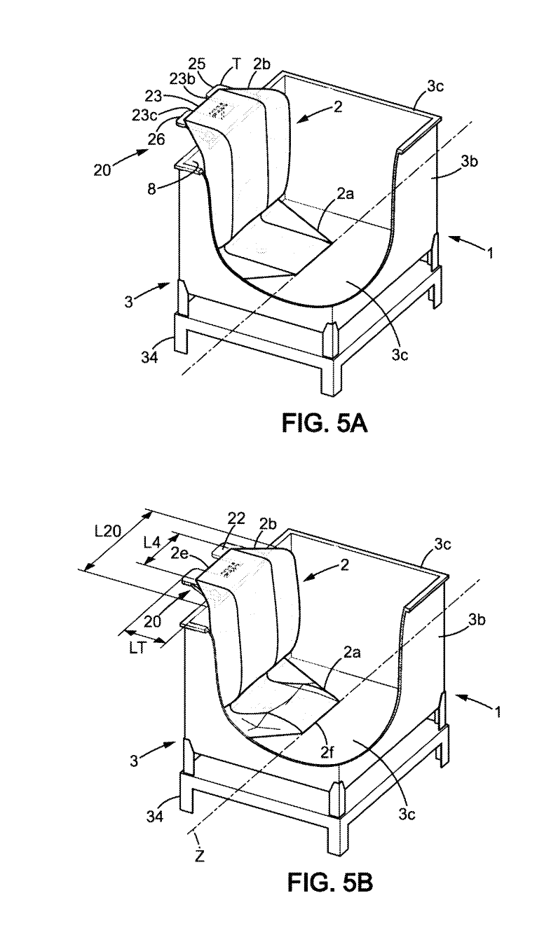

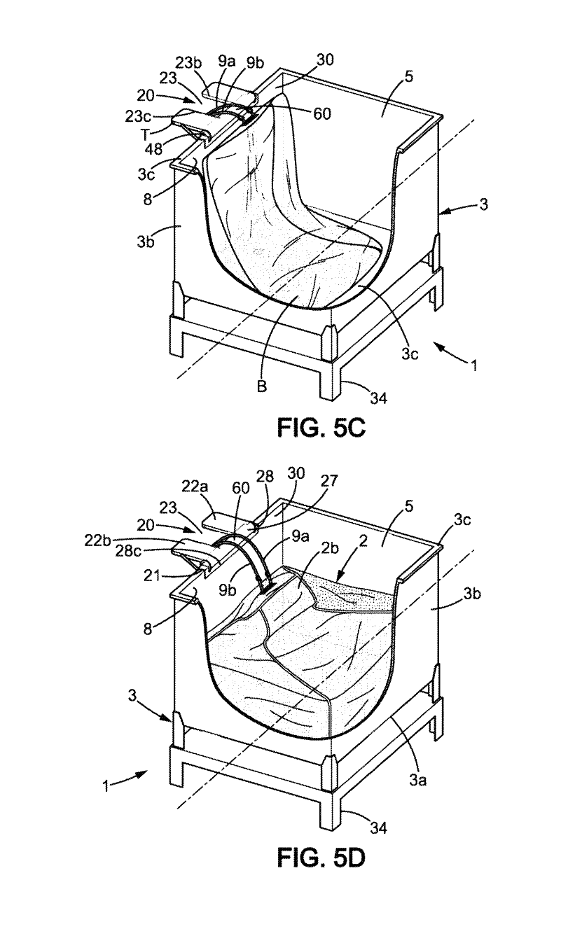

The lifting means T comprise, in this non-limiting example, a first shelf 25 and a second shelf 26 respectively defining a first surface portion 22a and a second surface portion 22b of the support surface 22. The first shelf 25 and the second shelf 26 are coplanar here and may possibly be connected to one another by an elongate portion 27 which is rotatable relative to the fastening element 21. As is clearly visible in FIG. 6, the elongate portion 27 extends parallel to the X axis and rotates around it to reach a folded configuration of the support device 20, in a position where it is folded towards the front panel 30. The elongate portion 27 may be integral with the shelves 25, 26, or may form a (radially inward) extension which is part of the lifting means T. Here, the elongate portion 27 defines a length L20 of the support device 20 which is, for example, greater than or about half the length of the determined side 15. The inner edge 27a of the elongate portion is, for example, located below the edge 3c in the folded position and above the edge 3c in a deployed position of the lifting means T. Of course, the length of the support device 20 can be adapted to requirements but it is preferable that the length L20 of the support device 20 be at least equal to the length L4 of the edge 2e defined at the upper end 2b of the 3D flexible pouch 2, as shown in FIG. 5B. The elongate portion 27 has an inner edge which may be straight and parallel to side 15. It is understood that in the deployed position, the support surface 22 extends, from the elongate portion 27, laterally outwards with respect to the given inner face 8, as can be seen in FIGS. 5C-5D.

In the radial direction, the length LT of the lifting means T may be greater than or equal to (L1−L2)/2, which allows supporting the entire upper end 2b of trapezoidal shape (see FIGS. 2A, 3, and 5A-5B). One will note that the upper ports 12a, 12b of the flexible pouch 2 are, for example, placed near the free edge 2e (straight in this case) formed at the upper end 2b, at a radial distance that is less than length LT.

Of course, other shapes and dimensions may be used for the lifting means T and/or for the flexible pouch 2, according to requirements. Furthermore, it is understood that the distance between the inner edge and the outer edge, defining length LT, may be less than the depth H5 of the storage housing 5, length LT preferably representing between 10 and 40% of depth H5. The support device 20 can thus be relatively compact and more simple to position.

As illustrated in FIG. 7, the fastening element 21 may comprise at least one positioning member 28, for example in the form of one or more U-section or J-section bars, possibly extending for a length identical or similar to that of the elongate portion 27. The positioning member 28 has an intermediate section 28a, horizontal here, which rests on the upper edge 3c in the assembly configuration. The bar or bars of the positioning member 28 also comprise for example a front arm 28b and a rear arm 28c extending from the intermediate section 28a and defining a cavity 29. The rigid container 3 may possibly have a flange, forming the determined side 15 of the upper edge 3c, which can be inserted into the cavity 29. Of course, one or more notches may be provided in the front arm 28b or in the rear arm 28c.

More generally, it is understood that an upper portion of the rigid container 3, which forms part of the frame surrounding the opening 4, can form a bearing area with preferably three faces each facing one of the inner faces of the positioning member 28. The bearing area, which fills the cavity 29, comprises a front surface portion which may be formed by the upper end 30a of the front panel 30.

The front arm 28b and rear arm 28c extend on both sides of the upper edge 3c in the assembly configuration and allow maintaining the support device 20 on the upper edge 3c. These front 28b and rear arms 28c are parallel for example, as can be seen in FIG. 7. For optimum support, the positioning member 28 may have a U-shaped cross-section and the two arms 28b-28c are separated by a distance greater than the thickness e of the determined side 15 of the upper edge 3c. Of course, a plurality of cavities 29 may be defined by the arms 28b-28c (or tabs) and the intermediate section 28a, for example to form several clasping attachment areas F1, F2 on an upper portion of the rigid container 3. This is the case, for example, for the support device 20 shown in FIG. 6.

When the support surface 22 defines a horizontal or substantially horizontal plane, the cavity 29 (longitudinal here) defined by the lower face of the fastening element 21 opens vertically onto the side opposite the support surface 22 and opens horizontally at at least one of the ends 21a and 21b of the fastening element 21.

Referring to FIGS. 1 and 7, the locking of the fastening element 21 on the upper edge 3c can be carried out by clamping means 41 that lock the positioning member 28 in position. In the embodiment of FIG. 7, one can see that the positioning member 28 and the clamping means 41 form at least one clasping element that allows detachable attachment of the support device 20. By way of non-limiting example, the clamping means 41 comprise an elongate element 42, here a rod provided with a suction cup V which defines a first support end 42a. The first support end 42a can be moved to come into contact with an outer face of the rigid container 3, for example the outer face of the front panel 30. A second end 42b of the elongate element 42 has or supports a clamping adjustment element 43. A nut or similar member thus advances the elongate element 42, and a rotatable handle or similar gripping member may be part of element 43 to facilitate locking and unlocking the clamping means 41.

The clamping adjustment element 43 can be used, for example, in the folded configuration of the lifting means T (as in FIG. 6) in order to adjust the clamping force on the upper end 30a of the front panel 30 or similar surface of the bearing area. The clamping adjustment element 43 is preferably movable relative to the elongate element 42 and engages with the second end 42b of the elongate element 42. The clamping adjustment element 43 has, for example, a tubular portion providing an internal thread that cooperates with a threaded portion of the elongate element 42. More generally, it is understood that the clamping adjustment element 43 is mounted so that it engages with the second end 42b in order to adjust the relative position of the elongate element 42 relative to one of the arms 28b-28c, here the front arm 28b of the positioning member 28.

As illustrated in FIGS. 6-7 in particular, the clamping adjustment element 43 may engage the given arm 28b, directly or indirectly. This locks the element 43 in translation. It is understood that by extending the portion of the elongate element 42 which is located in the cavity 29, the clamping force against the part of the rigid container 3 which is inserted in this same cavity 29 is increased and the support device 20 cannot be disengaged accidentally. The position of the positioning member 28 is locked. To remove the support device 20, one simply manipulates the clamping means 41 by actuating the adjustment element 43, for example with a rotational movement in the example illustrated, so as to move the elongate element 42 rearwards and thus reduce the length of the portion of the elongate element 42 which is located in the cavity 29.

One advantage of using a fastening element 21 which clamps to engage is that this facilitates adjusting the position of the support device 20 on the determined side 15 of the upper edge 3c. It is possible to slide the clasping element or elements 28 41 on the upper edge 3c, for example to center the slot 23. It is preferable that the slot 23 be located in a central position on the determined side 15, such that there is a virtual vertical midplane P passing through the slot 23 and possibly through the through-hole 6a, as shown in FIG. 3.

When the support device 20 has lifting means T hinged about an axis X, locking in the deployed operating position (position shown in FIGS. 1, 3, 4A-4B, 5A-5D, and 7) can be achieved by contact against a stop 46 which is integral with the fastening element 21 attached to the rigid container 3. Bearings 48 may be provided in the fastening element 21 to permit rotation of the rotationally movable lifting means T about axis X which defines a longitudinal axis of the fastening element 21.

Referring to FIG. 7, the bearing 48 has a guide slot 49 that extends around the longitudinal axis X, to guide the rotational movement of all or part of the lifting means T. This guide slot 49 respectively defines a rear stop or abutment 46 and a front stop 45 located lower than stop 46 in the mounted configuration of the support device 20 and more forward relative to the front arm 28b. Stop 46 stops rotational movement when the deployed position of the lifting means T is reached, while front stop 45 defines the end of travel corresponding to the folded position of the lifting means T. In this non-limiting example, one or a plurality of hinged locking members 51 in the form of a connecting pin or the like, connect the lifting means T to the fastening element 21 in order to lock and maintain the lifting means T in the deployed position. Thus, in this deployed position, the support surface 22 can extend and be maintained at a height level at least equal to the height level of the determined side 15 of the upper edge 3c.

The hinged locking member 51 has, in the embodiments of FIGS. 1 and 7, a connecting end 51a for connecting to the fastening element 51. This connecting end 51a pivots about a secondary axis Y located lower than the longitudinal axis and lower or substantially at the same level as the front stop 45. The hinged locking member 51 has another end 51b connected to a pivot 52 formed laterally on one of the shelves 25, 26 or similar part of the lifting means T. The position of the pivot 52 and the dimensions of the guide slot 49 are adapted so that each of the shelves 25 and 26 extends in a coplanar and substantially horizontal manner in the deployed position. The support surface 22 here allows, in this deployed position, supporting the upper end 2b of the flexible pouch 2 at a higher height level than the upper edge 3c.

Of course, it is possible to obtain the hinge of the lifting means T with other types of mechanism for locking the deployed position. In the example of FIG. 10, the hinged locking member 51 is eliminated and another form of locking is used, for example a wedge which is inserted beneath the lifting means T once the deployed position is obtained.

The lifting means T have at least one insertion member such as a pin 53 for engagement with stop 46 in the extended position. Two pins 53 protruding in a direction parallel to axis X, in opposite directions, may be formed for example on either side of the lifting means T in order to engage respectively with one and the other of the ends 21a and 21b of the fastening element 21. In FIG. 7, the projecting pin 53 or similar insertion member extends outwardly from a side portion of shelf 25 and moves in the guide slot 49 between stops 45 and 46.

Of course, the lifting means T may be designed without any hinge, and in this case the bearings 28 and mobile connection elements can be eliminated. The lifting means T define a support surface 22 which extends transversely to the front panel 30 of the rigid container 3. More generally, it is understood that the lifting means T extend between at least one outer edge (at a distance from the opening 4) and an inner edge 55 adjacent to the upper opening 4 when the support device 20 is in the mounted state on the rigid container 3. The support surface 22 extends transversely outwards from the inner edge 55 to the outer edge, forming an upper face of the support device 20. The slot 23 opens for example to the exterior on the outer edge side which can be divided into two discrete outer edge portions 54a and 54b.

Preferably, the lifting means T extend radially for a distance LT at least equal to half the width of the slot 23. The slot width is also typically less than one third of the length of the determined side 15. This arrangement makes it possible to obtain a support surface 22 large enough in both directions to maintain a flat configuration of the upper end 2b of the flexible pouch 2, while the slot 23 is dimensioned to effectively guide the flexible supply lines 9a, 9b, for example between two lateral edges 23b and 23c formed by the shelves 25 and 26. This guidance can be seen in particular in FIGS. 5A to 5D.

The slot 23 here is wide enough to allow the passage of at least two flexible supply lines 9a, 9b connected to respective upper ports 12a and 12b of the flexible pouch 2, when the upper end 2b is resting on the support surface 22. The slot 23 passes vertically through the lifting means T, so that the flexible supply lines 9a, 9b run below the lifting means T and next to the front panel 30 by traversing the slot 23 between the inner edge 55 and the outer edge 54a, 54b.

Referring to FIGS. 1, 5C-5D, and 6, the support device 20 comprises, on the side of the inner edge 55, a convex guide surface 60 which extends between the two surface portions 22a and 22b and defines an end 23a of the slot 23. The guide surface 60 is opposite to the inner face of the fastening element 21 and may, for example, be defined by all or part of an upper face of the elongate portion 27. This guide surface 60 lies above the level of the upper opening 4, covering a portion of the upper edge 3c on the determined side 15, in the mounted state of the support device 20. The support surface 22 extends generally in a plane which intersects the guide surface 60 or lies above the guide surface 60. In other words, the support surface 22 maintains the upper end 2b of the flexible pouch 2 to be filled outside the storage housing 5 and at a predefined height level which is at least equal to the level of the guide surface 60. The inner edge 55 of the lifting means T may be defined by the side of the guide surface 60 opposite to the slot 23.

FIG. 2B and FIG. 3 show that the 3D flexible pouch 2 may initially be folded against the inner edge 55 of the lifting means T, with the support device 20 mounted on the container 3 and in the extended position. The upper end 2b of the flexible pouch 2 then lies parallel to the support surface 22 which is substantially planar prior to filling. An angle A can thus be formed, in the area in contact with the guide surface 60, between the first portion 14a and second portion 14b of the given face 14 of the flexible pouch 2.

This angle A is, for example, between 60° and 130°, and preferably between 70 and 110°. An angle of about 90° and less than 100° may be preferred to facilitate maintaining the upper end 2b outside the storage housing 5 as filling begins, while effectively guiding the flow through the flexible pouch 2 to the lower end 2a.

The second portion 14b may run parallel to the inner face 8 which is flat (and typically vertical) when filling has not begun or has not sufficiently advanced to deform the second portion 14b significantly. Under these conditions, it is understood that angle A is the angle formed between the support surface 22 and the inner face 8 of panel 30, as can be inferred from FIGS. 3B and 4A. Although these figures show an angle of approximately 90°, it is understood that the lifting means T may be positioned differently, as the inclination defined by the support surface 22 can make this angle smaller (down to 60° for example) or larger (up to 130° for example).

The guide surface 60 has, for example, a continuous rounded C-shaped cross-section. It extends in a longitudinal direction parallel to the fastening element 21, just above this fastening element 21. The profile of the guide surface 60 may be the same along the length of the guide surface 60, this length corresponding to the distance between the lateral edges 23b and 23c, which here are parallel to one another. The curvature of this profile, with no significant reliefs or protruding angles, allows the flexible lines 9a, 9b to slide smoothly under the effect of deployment of the flexible pouch 2 at its lower end 2a. This rounded profile guides the change in orientation of the ports 12a, 12b, which transition from a downward orientation to an upward orientation. This change in orientation is illustrated by the sequence of FIGS. 5B, 5C, and 5D.

A half-pipe bend can be formed from end 23a of the slot 23 (or lower) to the opposite side which can define an intermediate portion of the inner edge 55 of the support surface 22, passing over the positioning member 28 of the fastening element 21. By way of non-limiting example, the guide surface 60 extends for a height H which is preferably at least equal to 2 cm, more preferably at least equal to 4 cm. It is therefore understood that this defines a bulge which defines a smooth transition between the lowest level of the guide surface 60 and the highest level. The portion of the guide surface 60 which defines end 23a of the slot 23 extends below the support surface 22 defined by the lifting means T in the deployed position. Thus, the supply lines 9a, 9b can engage the guide surface 60 well before the associated upper ports 12a, 12b are introduced into the storage housing 5.

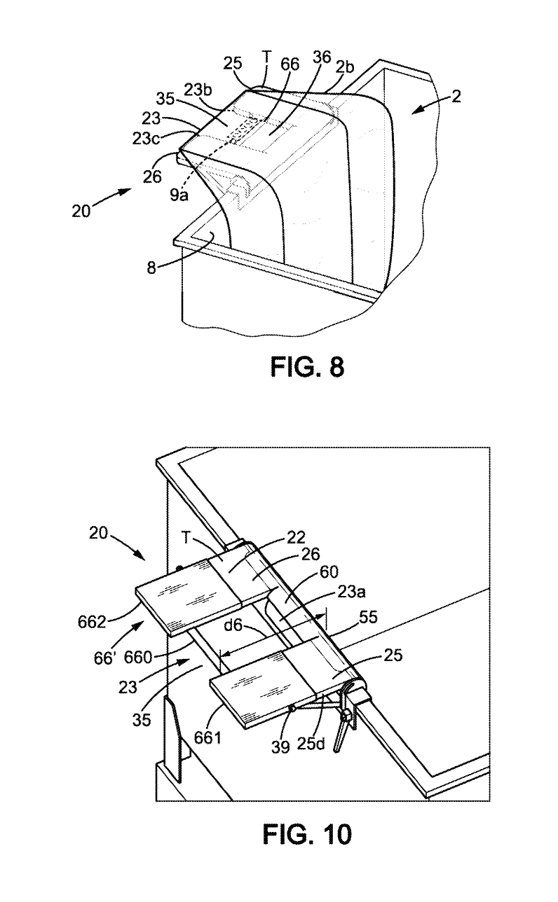

Referring to FIG. 8, an additional contact surface for contact with the flexible supply line 9a and possibly other adjacent flexible lines 9b is provided. Here, this additional surface is defined by a spacer member 66 which extends transversely to the slot 23 and extends from one to the other of the two shelves 25, 26. The spacer member 66 may be in the form of a roller that is optionally rotatable, a bar with a convex outer surface, a flat element with rounded ends, or other suitable shape, preferably extending parallel to the determined side 15. The spacer member 66 preferably has a greater rigidity than the constituent material of the flexible lines 9a, 9b, at least in the portion forming the additional contact surface. The spacer member 66 may extend across the slot 23 so as to define a front space 35 and a rear space 36 between the shelves 25 and 26. Alternatively, the spacer member 66 may extend below the level of the slot 23.

The flexible supply line 9a is thus initially held away from the guide surface 60, preferably extending outside the rear divider space 36 as shown in FIG. 8. It is understood that the spacer member 66 limits the insertion path of the flexible supply line 9a in the slot 23, and thus better maintains the upper end 2b of the flexible pouch 2 outside the storage housing 5. The spacer member 66 may be secured to one and/or the other of the shelves 25, 26. More generally, the spacer member 66 may be mounted on the lifting means T at the front of the guide surface 60, removably or fixedly, possibly with space.

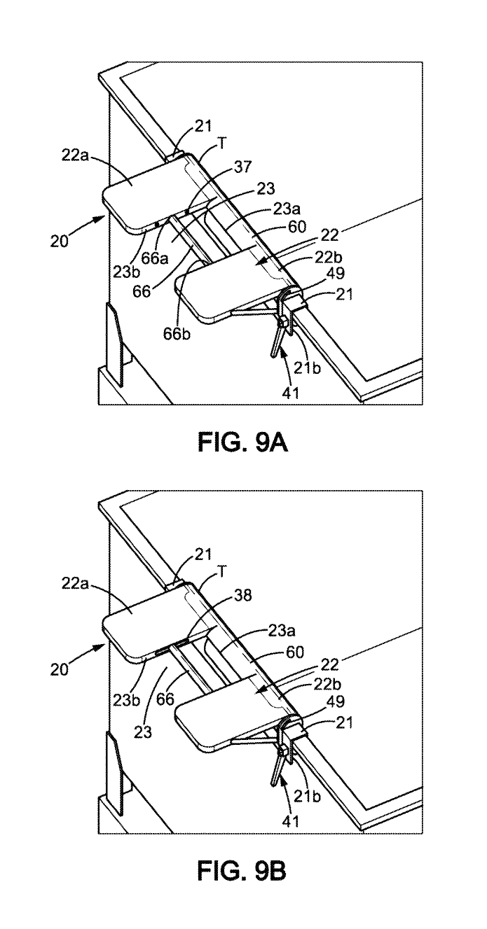

Referring to FIG. 9A, the mounting position of the spacer member 66 may be selected from a plurality of positions that are more or less close to the rear end 23a of the slot 23. Predetermined anchoring elements 37 can thus be formed on the edges 23b and 23c defining the slot 23. Each of the ends 66a and 66b of the spacer member 66 is then held securely on the corresponding anchoring element 37. The anchoring elements 37 may be reliefs, in male and/or female form. Attachment can be achieved for example by engagement between recesses and elastically deformable protruding projections. Any other type of attachment can of course be used, for example a magnetic attachment or clamping attachment. In addition, the location of the attachment may vary, with an area of attachment in the slot 23, near the slot 23, or at a distance from the slot 23.

Referring to FIG. 9B, the mounting position of the spacer member 66 can be adjusted similarly to what is illustrated in FIG. 9A, but with the use of a pair of continuous grooves 38 that allow sliding the spacer member 66 in a direction perpendicular to the panel 30 in the mounted position of the support device 20. One can thus move the spacer member 66 easily and with more flexibility. The spacer member here traverses the slot 23, parallel to the determined side 15. Sliding with friction may be preferred to avoid using a specific device to prevent sliding. Alternatively, the spacer member 66 may be configured to engage and lock into place in at least one of the grooves, for example by actuating a quarter-turn rotation of the spacer member 66. More generally, any system for locking the spacer member 66 in position may be used.

Referring to FIG. 10, here the spacer member 66′ is implemented as an assembly that can be fitted onto one or more ends at the front of the lifting means T. When the lifting means T comprise two shelves 25, 26, the spacer member 66′ may have:
a first sheath 661 surrounding shelf 25;
a second sheath 662 surrounding shelf 26;
an intermediate portion 660 extending across the slot 23 or under the slot 23, and extending between the first sleeve 661 and second sleeve 662 to form the contact surface for the supply line or lines 9a, 9b.

Positional adjustment of the intermediate portion 660 is achieved by sliding each of the first and second sleeves 661, 662. Although the shelves 25, 26 and the sleeves 661, 662 here have an identical format with equal dimensions, it is understood that different general shapes and different dimensions may be used, in particular for the dimension in the direction perpendicular to the wall 30. The locking in position of the intermediate portion 660, functionally equivalent to the spacer member 66 of FIGS. 9A-9B, is achieved for example by the engagement of at least one clamping device 39, integral with sleeve 661 or 662, with a support surface of a corresponding shelf 25 or 26. This support surface, here formed by the outer edge 25d away from the slot 23, is preferably separate from the surface portions 22a, 22b that form the support surface 22.

More generally, it is understood that the distance d6 (see FIG. 10) between the front surface of spacer member 66 or 66′ and the inner edge 55 of the lifting means T can be changed to adapt to the size of the flexible pouch 2.

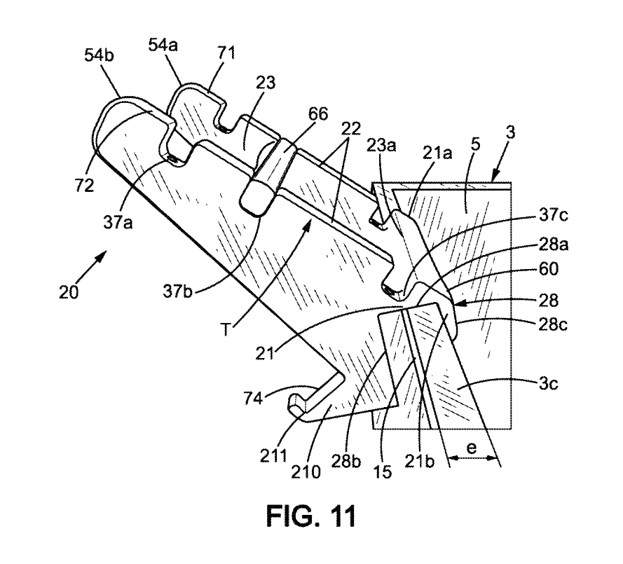

Referring to FIG. 11, a support device 20 is fixed on the determined side 15 of the upper edge 3c, here without clamping device, by screwing onto the container 3. In this example, the device 20 has a support surface 22, optionally formed by two uprights 71, 72, which is inclined in the deployed position. With such an inclination, it is understood that the position of the upper end 2b of the flexible pouch 2 is maintained outside the storage housing 5, and at a height level that is higher than the case illustrated in FIGS. 4A and 5A. In particular, angle A can be greater than 90°, preferably between 104° and 130°, with this configuration (ascending) of the support surface 22 in the deployed position which enables loading the flexible pouch 2.

The lifting means T, inclined to a position higher than the level of the upper edge 3c, move laterally away from the front wall 30 less than when the support surface 22 is substantially horizontal. With such an inclination, the forces exerted on the fastening element 21 due to the weight loaded on the support surface 22 can be reduced. The positioning member 28 of the fastening element 21 may have, for example, a U-shaped cross-section at least on the side of the two ends 21a, 21b. Arm 28c and arm 28b, which face one another, have a respective length much greater than thickness e, while the intermediate section 28a is almost as short as thickness e in order to minimize the clearance between the two arms 28b, 28c when the positioning member 28 is engaged on edge 3c.

In the example of FIG. 11, the support device 20 has an auxiliary fastening element 210 which may be adjacent to the fastening element 21 and which engages with the upper edge 3c of the container 3 in a manner comparable to the fastening element 21. The auxiliary fastening element 210 may have at least two hooks 211 or similar retaining members which here are formed on two opposite sides (near the ends 21a, 21b) of the support device 20, on either side of the rear end 23a of the slot 23. Each hook 211 may define a concave area of contact 74 with the upper edge 3c in a folded position that minimizes the size of the support device 20 around the container 3.

Thus, even if the support surface 22 is not movable relative to the fastening element 21 (no folding), it is still possible to move the support surface 22 between two positions:
a folded position, typically similar to the case illustrated in FIG. 6, with attachment of the support device 20 by the auxiliary fastening element 210, and
a deployed position clearly visible in FIG. 11, with attachment onto the edge 3c by the fastening element 21.

Functionally, the support device 20 is thus completely comparable to the variants of FIGS. 9A-9B. In particular, we also find a spacer member 66 whose position can be adjusted due to the presence of predetermined anchoring elements 37a, 37b, 37c, here in the form of notches. The support device 20 may optionally have a part formed as one piece that defines the fastening element 21, the auxiliary fastening element 210, and the lifting means T (without the spacer member 66, or with it in an option with no adjustment of the spacer member 66).

A filling process with deployment of the 3D flexible pouch 2, using the support device 20 fastened on the upper edge 3c of the rigid container 3, will now be described by way of non-limiting example, with reference to FIGS. 2A-2C, 3, 4A-4B, and 5A-5D.

The flexible pouch 2, having its upper end 2b placed on the support surface 22, is connected to the pumping device 10 by at least one flexible supply line 9a, 9b. This connection is made externally to the storage housing 5, and the flexible supply line or lines 9a, 9b hang from the upper ports 12a, 12b, traversing the slot 23 in the vertical direction, as shown in FIGS. 3 and 4A. At this pre-filling stage, the flexible pouch 2 is flat as shown in FIGS. 2B and 3. The flexible line 7 connected to port 11 of the lower end 2a may be engaged in the through-hole 6a. In this case, the flexible pouch 2 can then have two fold lines before filling, respectively near the upper end and near the lower end of the front panel 30.

The support device 20 here is placed on the upper edge 3c so that the slot 23 is substantially equidistant from the two connecting panels 32 and 33, as shown in FIG. 3. This positioning helps minimize or even eliminate the filling problems caused by folds formed along the connecting panels 32, 33.

Each of the supply lines 9a, 9b is initially at a distance from the guide surface 60 when the upper end 2b of the flexible pouch 2 is placed on the support surface 2. The lower end 2a of the flexible pouch 2 is initially maintained in the half of the storage housing 5 located on the side of the inner face 8. The pouch 2 is thus kept away from the distal wall 31, opposite the inner face 8, so that the distal wall 31 does not prevent the lower end 2a from unfolding along an unfolding line Z parallel or substantially parallel to axis X. FIG. 3 shows a possible placement of the unfolding line Z. In practice, in the case of a flexible pouch 2 as shown in FIG. 2A, this unfolding line Z can typically coincide with the free edge 2f (a rectilinear edge here) of the pouch 2.

It can be seen in FIGS. 4A and 5B that the support device 20 maintains the upper end 2b outside the storage housing 5 during a filling phase which corresponds to the beginning of unfolding of the bottom wall W1. This maintaining of the upper end 2b is advantageous as it allows gradual expansion of the bottom wall W1. A gradual and smooth (even) deployment avoids any incorrect positioning of the bottom wall W1, which should cover all or almost all of the bottom 3a when the flexible pouch 2 is in a filled state as shown in FIG. 2C.

FIGS. 4A and 4B schematically represent the unfolding which takes place during filling, at the bottom wall W1 around the unfolding line Z. Such unfolding occurs for example when the filling reaches between 5 and 30% of the capacity of the flexible pouch 2, typically around 10%.

FIG. 5B shows a filling state of the flexible pouch 2 which precedes an unfolding to more than 90° around the unfolding line Z. One can see that the upper port or ports 12a, 12b can be moved along the slot 23, at least at the beginning of filling. Then the flexible pouch 2 reaches a filling state in which the unfolding around the unfolding line Z (here coinciding with the position of edge 2f) is at about 180°, as shown FIG. 4B and FIG. 5C in particular. The unfolding angle corresponds to 180° in the case of a bottom 3a that is substantially planar, and it is more generally understood that the unfolding occurs in a manner that is adapted to the surface of the bottom 3a.

At least during the beginning of filling, the slot 23 separating the support surface 22 into two surface portions 22a, 22b guides the advancement of the upper end 2b toward the upper opening 4. Due to this guidance, a major portion of the flexible pouch 2 is still kept close to the inner face 8 and no retention area for biopharmaceutical product B is created at a distance from the bottom wall W1. The height level of the ports 12a, 12b here is at least equal to the height level of the upper edge 3c, which facilitates the flow of biopharmaceutical product B in the direction of the storage housing 5, towards the lower end 2a. The filling fluid flows freely into the pouch (without impediment).

When the bottom wall W1 is sufficiently unfolded, as shown in FIGS. 4A and 5C, each supply line 9a, 9b, guided between the lateral edges 23b and 23c defining the slot 23, can engage with the guide surface 60. The curvature of the convex guide surface 60, which preferably descends lower than the height level of the support surface 22, eliminates the risk of a supply line 9a, 9b catching on a wall of the rigid container 3. The rounded profile of the guide surface 60, with no projecting angles or significant edges, prevents the flexible supply lines 9a, 9b from catching. The guide surface 60 here extends radially for a distance which may be greater than the thickness e of the determined side 15 of the upper edge 3c. It is therefore understood that these supply lines 9a, 9b cannot be bent to an angle less than or equal to 90° around the guide surface 60.

The upper end 2b can enter the storage housing 5 completely, due to the reduction in height of the flexible pouch 2 during filling (as can be seen by comparing FIGS. 2A and 2C). The upper end 2b is still substantially flat, as shown in FIG. 5C. It is understood that the unfolding at the top wall W2 (along edge 2e) is delayed and can begin after the unfolding that occurs at the bottom wall W1 (unfolding along edge 2f, under the effect of the accumulation of biopharmaceutical fluid B in the lower portion of the storage housing 5). One advantage of the method is that the displacement of the upper end 2b occurs passively, under the effect of this accumulation which increases the mass and volume of the assembly formed by the flexible pouch 2 and the biopharmaceutical product B that it contains.

When a spacer member 66 or 66′ is used, as shown in FIGS. 8, 9A-9B, and 10, the flexible supply line or lines 9a, 9b come into position through the front space 35 and abut against the spacer member 66 or 66′. This position of the flexible supply lines 9a, 9b also encourages the delaying of the unfolding at the top wall W2. The position of the front surface of the spacer member 66 or 66′ (more or less distant from the inner edge 55) can be adjusted according to the size of the flexible pouch 2, by moving the attachment or clamping area of the spacer member 66 or 66′ relative to the lifting means T.

The flexible pouch 2 can thus move gradually and continuously, without impediment. Optimal filling is obtained to a filling state greater than or equal to 50%, as shown in FIG. 5D. No human intervention is required to reposition the flexible pouch 2, in particular at the time of deployment of the bottom wall W1 around the fold line Z.

It is understood that guiding the fluid is simple when filling begins, since there is no fold aside from the gradual fold line formed by rolling the upper end 2b around the convex guide surface 60 bordering the upper opening 4. Then, as shown in FIGS. 4A and 5C, the supply lines 9a, 9b also roll over the convex guide surface 60 and thus gradually travel over the upper end 2b without catching. The volume of biopharmaceutical fluid B in the flexible pouch 2 is then already large enough and the bottom wall W1 has unfolded enough to prevent twisting or the formation of significant wrinkles in the flexible pouch 2. Moreover, the guidance provided by the slot 23 ensures that the upper ports 12a, 12b remain positioned closer to the front panel 30 than to any of the other panels 31, 32, 33 of the side wall 3b.

Once the flexible pouch 2 is correctly deployed with its content of biopharmaceutical fluid B (filling has ended), the support device 20 can be placed in the folded position, to facilitate access to inside the container 3 and to the disposable flexible pouch 2. The folded position does not obstruct the operator and reduces the overall dimensions.

1-26. (canceled)

27. A method for loading a 3D flexible pouch in a storage housing of a rigid container of a predetermined depth, wherein the flexible pouch is adapted for filling with a biopharmaceutical product by means of at least one flexible supply line, the container comprising an upper edge defining an upper transverse opening for access to the storage housing, the method comprising, prior to filling, the steps of:
extending the flexible pouch, in an initial non-filled state, along a given inner face of the storage housing, so as to define a lower end and an upper end which are arranged on either side of said upper transverse opening, wherein the upper end of the flexible pouch comprises at least one upper port to which said flexible supply line is connected, said upper port being arranged on a given face of the flexible pouch in the initial non-filled state;
maintaining the upper end outside of the storage housing; the method further comprising the following steps:
providing a support surface on the rigid container, by means of at least one support device mounted along a determined side of the upper edge,
orientating and positioning the flexible pouch so that a first portion of the given face of the flexible pouch is face to face with the given inner face and so that a second portion of said given face of the flexible pouch is in contact with the support surface, such that said flexible supply line connects to the flexible pouch from underneath the support surface, and
before or during filling, inserting said flexible supply line into a slot that separates said support surface into two surface portions, while keeping the second portion of the given face, which is part of the upper end of the flexible pouch, placed against the support surface,
during filling, guiding said supply line by a convex guide surface provided in the support device and extending between the two surface portions, the guide surface covering a portion of the upper edge of the rigid container and delimiting one end of the slot, whereby the supply line can be lifted above the upper edge during filling, when the upper end of the flexible pouch is moved into the storage housing.

28. The method according to claim 27, wherein the support surface is placed on the rigid container so as to extend transversely and laterally outwards relative to the given inner face of the storage housing, whereby the upper end of the flexible pouch is in a laterally offset position relative to the storage housing when the upper end is resting on the support surface.

29. The method according to claim 27, comprising, before filling, the step of:
connecting another flexible line to a lower port located in the lower end of the flexible pouch, and inserting this other flexible line into a through-hole to pass through the bottom of the storage housing.

30. The method according to claim 27, comprising the steps of:
filling the flexible pouch using at least one flexible supply line and a corresponding number of upper ports provided in the upper end of the flexible pouch, on the given face; and
during filling, guiding the at least one flexible supply line by the convex guide surface.

31. The method according to claim 27, wherein two flexible supply lines are inserted into the slot which extends between two coplanar shelves.

32. The method according to claim 27, wherein the flexible pouch has a capacity of between 100 and 1000 L, the storage housing of the rigid container containing the entire contents of the flexible pouch in a filled state.

33. The method according to claim 27, wherein the support device is removably attached on the determined side of the upper edge, by clasping.

34. The method according to claim 27, wherein the upper end of the flexible pouch is placed at a height level at least equal to a height level of the determined side of the upper edge, when it is resting on the support surface.

35. The method according to claim 27, wherein the support surface and the given inner face form planes which are secant, so that an angle formed between said first portion and said second portion is between 60° and 130° prior to filling.

36. The method according to claim 27, wherein the second portion of said given face is part of the upper end of the flexible pouch, the upper end of the flexible pouch being moved to inside the storage housing in a passive manner due to increase in mass and volume of assembly formed by the flexible pouch and the biopharmaceutical product contained in the flexible pouch.

37. The method according to claim 27, wherein the support surface is moved from a folded position to a deployed position that enables the support surface to support the upper end of the flexible pouch at a height level that is higher than the upper edge.

38. The method according to claim 37, wherein the deployed position is locked by the contact of at least one pin that is integral in rotation with the support surface, against a stop of the support device which is integral to a fastening element attached to the rigid container.

39. The method according to claim 27, wherein the upper end of the flexible pouch extends parallel to the support surface which is substantially planar, prior to filling,
and wherein the flexible supply line is initially placed at a distance from the guide surface when the upper end of the flexible pouch is placed on the support surface, the insertion of the flexible supply line into the slot optionally being limited by a spacer member integral to the support device, and the lower end of the flexible pouch is initially maintained at a distance from a distal wall of the container opposite to the given inner face of the container, the unfolding of the flexible pouch along the bottom of the storage housing allowing, as the flexible pouch is filled, a pulling of the upper end of the flexible pouch inwardly into the storage housing, so that said flexible supply line engages with and moves against the guide surface.

40. A system for loading and storing a 3D flexible pouch to be filled with a biopharmaceutical product by at least one flexible supply line located at an upper end of said flexible pouch, for the implementation of the method according to claim 27, the system comprising a rigid container having a bottom, a side wall extending longitudinally from the bottom to an upper edge defining an upper transverse opening, so as to define a storage housing for receiving the flexible pouch in a filled state, the storage housing being accessible through the upper transverse opening;
wherein the system comprises, on a determined side of the upper edge, a support device which comprises:
a fastening element on said determined side of the upper edge;
a lifting device means which extends between an inner edge adjacent to the upper transverse opening and at least one outer edge, the lifting device defining a support surface extending transversely outwards from the inner edge to said outer edge, the support surface being adapted to maintain the upper end of the flexible pouch to be filled outside of the storage housing;
a slot which separates said support surface into two surface portions, suitable for the passage of the flexible supply line when the upper end of the pouch is resting on the support surface, the slot preferably opening to the exterior on the side of the outer edge;
a convex guide surface which extends between the two surface portions and defines one end of the slot, the guide surface covering a portion of the upper edge.

41. The system according to claim 40, wherein the support surface extends at a height level at least equal to height level of the determined side of the upper edge.

42. The system according to claim 40, wherein the convex guide surface has a continuous rounded C-shaped cross-section.

43. The system according to claim 40, wherein a distance between the inner edge and the outer edge is smaller than the smallest dimension of the storage housing.

44. The system according to claim 40, wherein, to allow detachable attachment of the support device on the determined side of the upper edge, the fastening element comprises at least one clasping element which comprises:
a positioning member having a U-shaped cross-section forming two parallel arms spaced apart by a distance greater than a thickness of the determined side of the upper edge; and
clamping pieces to lock the positioning member in place.

45. The system according to claim 44, wherein the clamping pieces comprise:
an elongate member which defines a first support end intended to be in contact with an outer face of the rigid container, a second end which traverses a given arm among the arms of the positioning member, and
a clamping adjustment element that is movable relative to the elongate element and that engages with the second end of the elongate element in order to adjust the relative position of the elongate element with respect to the given arm.

46. The system according to claim 45, wherein the slot is located in a central position on the determined side, such that a virtual vertical midplane exists which passes through the slot and through the through-hole.

47. A support device adapted to be combined with a rigid container to form the loading and storing system according to claim 40, the support device comprising:
at least one fastening element which extends longitudinally between two ends and has a lower face for attachment to a determined side of a rigid container upper edge;
a lifting device which extend between at least one outer edge and an inner edge adjacent to the upper transverse opening in a state where the support device is mounted on the rigid container, the lifting device defining a support surface extending transversely outwards from the inner edge to the outer edge, the support surface forming an upper face of the support device;
a slot separating said support surface into two surface portions, the slot defining a front passage for the flexible supply line when the upper end of the pouch is resting on the support surface;
a convex guide surface which extends between the two surface portions and defines a rear end of the slot, the guide surface being opposite to the inner face of said fastening element and configured to cover a portion of the rigid container upper edge in a state where the support device is mounted on the rigid container, the support surface generally extending in a plane which intersects the guide surface or lies above the guide surface, such that the support surface maintains the upper end of the flexible pouch to be filled outside of the rigid container and at a predefined height level.

48. The support device according to claim 47, wherein the convex guide surface comprises a rear end portion of the support surface, extending in a longitudinal direction parallel to the fastening element and having a continuous rounded C-shaped cross-section,
and wherein, when the support surface defines a horizontal plane, the lower face of the fastening element defines at least one longitudinal cavity opening vertically onto a side opposite from the support surface and opening horizontally via at least one of the ends of the fastening element.

49. The support device according to claim 47, comprising:
a first shelf for defining all or part of one of the two surface portions of the support surface,
a second shelf for defining all or part of the other of the two surface portions of the support surface,
wherein the first shelf and the second shelf are coplanar and each have a lateral edge forming a side of the slot, the slot opening to the exterior on the outer edge side.

50. The support device according to claim 49, comprising a spacer member distinct from the guide surface and extending transversely to the slot between two ends of which one is integral to the first shelf and the other is integral to the second shelf, the spacer member being offset frontward relative to the rear end of the slot.

51. The support device according to claim 50, wherein the spacer member defines a front surface oriented toward a front end of the slot and is adjustable in position relative to the lifting device so as to adjust a distance between the front surface and the inner edge of the lifting device.

52. The support device according to claim 47, comprising:
a hinge on the fastening element, so that the lifting device is movable in rotation, about a longitudinal axis of the fastening element, between a folded position and a deployed position,
at least one guide slot formed on the fastening element, about the longitudinal axis, to guide a rotational movement of all or part of the lifting device, the guide slot respectively defining a front stop and a rear stop, the rear stop preventing said rotational movement when the deployed position of the lifting device is reached, and
at least one locking member adapted for locking the lifting device in the deployed position.
